(19) United States
(12) Patent Application Publication
(10) Pub. No.: US 2021/0173937 A1
(43) Pub. Date: Jun. 10, 2021

(54) CYBER ATTACK DETECTION SYSTEM

(71) Applicant: LUMU TECHNOLOGIES, INC., Miami, FL (US)

(72) Inventors: Javier Fernando Vargas, Bogota (CO); Claudio Deiro, Bogota (CO); Ricardo Villadiego, Doral, FL (US)

(73) Assignee: LUMU TECHNOLOGIES, INC., Miami, FL (US)

(21) Appl. No.: 16/953,283

(22) Filed: Nov. 19, 2020

Related U.S. Application Data
(60) Provisional application No. 62/946,341, filed on Dec. 10, 2019.

(51) Int. Cl. G06F 21/57; G06F 21/56

(52) U.S. Cl. CPC G06F 21/577; G06F 2221/034; G06F 21/566

(57) ABSTRACT

Threat assessment tool that monitors network activity within and arriving at an entity's network and to identify activity that matches known threats or that deviates from the norm. Once a threat is identified, it is reported. If the activity is out of the norm, it is also reported. All of the activity is then stored for further threat assessments to create a feedback loop mechanism that continues to increase the robustness of the assessment.

### BACKGROUND

In an interconnected computer system, a data breach occurs when a cyber attacker is able to obtain unauthorized access to one or several of the elements in the system(s). Typically the cyber attacker's objective in breaching a system is to exfiltrate valuable data, such as Personally Identifiable Information (PII), Intellectual Property (IP), commercial secrets, client lists, trade secrets, business strategies, financial accounts, among others. In a high majority of the cases, the exfiltration of such data occurs when the cyber attacker is able to utilize his or her infrastructure to gain access to one or more elements of another's system (i.e., the targeted system). The access to the targeted system elements is typically attained through the network elements that connect, or are connectable to, or that provide data egress or ingress to the different elements of the target system.

The number of and the frequency of the occurrence of data breaches have grown significantly over the past 10 years. The data breaches constitute a major security concern and, this concern leads to heavy investment in the development and deployment of prevention and detection technologies.

Prevention of these security incidents greatly relies upon the ability to detect the incidents with a high level of precision. Given the fact that cyber attackers must utilize and rely upon the network in their efforts to breach a system, it follows that certain elements of the network can be useful in identifying when the network exposes behaviors associated with data breaches.

A significant issue in the prevention and implementation detection technologies is a pervasive false sense of security that system owners, users and operators may have.

This false sense of security can often times be enforced or encouraged by many factors. One such factor is the limitations on security testing. This can be due to technical complexities, man-hour support issues or cost. The false sense of security may also be the results of false assumptions made by and/or relied upon by system operators, dependency on third party software, reliability of procedures in place and the uncontrollable factor due to users of the system. Further, because adversaries may actually be inhouse personnel, the security procedures set up for users may exacerbate the false assumptions. In addition, security measures may have been implemented after an adversary has already penetrated a system and established a means for returning. A false sense of security can also be due to unknown issues of a system and/or software running on the system that simply may be compromise prone. Another issue that faces many companies is the time gap between addressing a breach and the detection of the breach. Even with top-notch security measures in place, if the time gap between the breach and the detection is too large, significant damage can occur prior to implementing a remedy.

Thus, there is a need in the art for a system and method that enables the various elements of the network to be monitored and analyzed to detect activity that may be commensurate with a breach.

### BRIEF SUMMARY

Embodiments of the present invention are directed towards software and/or hardware systems, components, programs, applications, computers, etc. that operate to monitor network activity within an entity's network and to identify activity that deviates from the norm. Once such activity is identified, the various embodiments may operate to flag such activity if it appears to potentially be part of an attack. The various embodiments of the present invention will be referred to as the Cyber Attack Detector System or CADS.

Extensive observation of the way data breaches occur can provide a good indication of the steps involved in the compromise process. Table 1 presents an exemplary overview of this process.

TABLE 1
Cyber Attack Sequencing

| | |
|---|---|
| Step 1 | A cyber attacker tricks employees to download a |
| | disguised piece of malware. This process is done |
| | typically using email as a vector of attack. |
| Step 2 | If the attack is successful, the now compromised |
| | device will attempt to connect with a host |
| | belonging to the cyber attacker seeking |
| | instructions and/or to exfiltrate information. |
| Step 3 | In cases where the compromised device does not |
| | have the cyber attacker's data of interest, |
| | it will attempt to spread the compromises to |
| | other computers within the now compromised |
| | network. |
| Step 4 | Once the cyber attacker gets access to |
| | information of value, he or she will attempt to |
| | exfiltrate it by contacting a host belonging to |
| | the cyber attacker, as similarly described in |
| | step 2. |

Exemplary embodiments of the CADS operate to detect cyber-attack sequencing as presented in Table 1, and/or variants thereof. Such activity can be detected by monitoring various network elements and traffic that is being passed between the network elements to identify cyber-attack sequencing. Exemplary network elements where cyber-attack sequencing can be detected and/or identified are described in Table 2. The network data identified in Table 2 is referred to herein as network metadata.

TABLE 2
Network Metadata Detection

| Network Metadata | Relevance |
|---|---|
| DNS Queries | Collecting DNS Queries provides context |
| | with regards to attempted connections |
| | from devices within the organization |
| | network or system towards an external |
| | device/system such as a cyber |
| | attacker's infrastructure. |
| Network Flows | Among other malicious behavior, network |
| | flows provide insights into an |
| | organization's devices that are |
| | controlled by the cyber attacker and |
| | attempts to move laterally. |
| Access Logs of Perimeter | In cases where the attacks avoid domain |
| Proxies or Firewalls | resolution, the traces of adversarial |
| | contacts will lie in the access log of |
| | firewalls or proxies, depending on the |
| | organization's network configuration. |
| Spambox | Email is the preferred method by attackers |
| | to deliver attacks to the organization's |
| | end-users. Analyzing the organization's |
| | spambox provide insights into the type of |
| | attacks an organization is receiving, but |
| | more importantly if end-users are accessing |
| | such attacks and the organization is at a |
| | high risk of compromise. |

An exemplary embodiment of the CADS comprises a method to decrease vulnerability of a system to attacks. The method includes the action of continuously interfacing to activity sources to gather a plurality of instances of real-time metadata. For each instance of real-time metadata, the embodiment conducts a threat assessment. The threat assessment includes first comparing each instance of the gathered real-time metadata to one or more of a plurality of known threat intelligence signatures. For each instance of real-time metadata that corresponds with one or more of the plurality of known threat intelligence signatures, the embodiment of the CADS reports the instance of real-time metadata as a threat. However, for each instance of real-time metadata that does not correspond with one or more of the plurality of known threat intelligence signatures, the embodiment then examines the instance of real-time metadata to determine if it is a suspected threat. For each instance of real-time metadata that is determined to be a suspected threat, the embodiment of the CADS, reports the instance of real-time metadata as a threat. Further, the CADS also augments the plurality of known threat intelligence signatures to include the suspected threat. Finally, the embodiment of the CADS archives each of the plurality of instances of real-time data into a metadata storage container to be utilized for further threat assessment. In various embodiments, the CADS may operate to interface to activity sources to gather a plurality of instances of real-time metadata by interfacing to each of a plurality of access points that are accessed by roaming devices, interfacing to each of a plurality of components within the system, interfacing to each of a plurality of cloud environments that interact with the system, gathering network flows, gathering entries in a firewall access log, gathering entries in a proxy access log, and/or gathering items routed to one or more of a plurality of spamboxes in the system. Further, the embodiment of the CADS may operate to examine the instance of real-time metadata to determine if it is a suspected threat by comparing the instance of real-time metadata to previously processed metadata. In another embodiment, the CADS may operate to examine the instance of real-time metadata to determine if it is a suspected threat by determining if the instance of real-time metadata matches previously processed metadata; and analyzing the occurrence of the instance of real-time data with occurrence of matching previously processed metadata to identify if the instance of real-time data is similar to the matching previously processed metadata.

Another embodiment of the CADS includes a system to decrease vulnerability of a system to attacks. The system includes a metadata collector that is configured to continuously interfacing to activity sources to gather a plurality of instances of real-time metadata; a known threat source containing one or more known threat signatures; a metadata store configured to contain metadata previously gather within the system; and a threat assessment system.

The threat assessment system includes a processor and a memory element containing instructions that when executed by the processor enable the threat assessment system to conduct the threat assessment. The embodiment performs the threat assessment by accessing the one or more known threat signatures in the known threat source and accessing the metadata collector to receive each of the instances of real-time metadata. The threat assessment system then compares each instance of the gathered real-time metadata to one or more of the plurality of known threat intelligence signatures. If the instance of real-time metadata corresponds with one or more of the plurality of known threat intelligence signatures, the threat assessment system then reports the instance of real-time metadata as a threat. If the instance of real-time metadata does not correspond with one or more of the plurality of known threat intelligence signatures, it interfaces to the metadata store to access the previously gathered metadata. For each such instance of the real-time metadata, the threat assessment system compares the instance of the real-time metadata to the previously gathered metadata. If the comparison shows the instance of real-time metadata is an anomaly, it reports the instance of real-time metadata as a threat based on the comparison and then augments the plurality of known threat intelligence signatures to include the suspected threat. Further, for each instance of real-time metadata, the system archives the instance of real-time data into the metadata storage container to be utilized for further threat assessment.

### BRIEF DESCRIPTION OF THE SEVERAL VIEWS OF THE DRAWING

FIG. 1A is a simplified block diagram illustrating the functionality of various embodiments of the CADS.

FIG. 1B is a block flow diagram illustrating an exemplary methodology to access network metadata to highlight compromises affecting an organization.

FIG. 2 is a flow diagram illustrating an exemplary method to capture real-time network metadata for multiple environments

FIG. 3 is a general flow diagram of an exemplary process performed in exemplary embodiments of the CADS.

FIG. 4 presents a conceptual depiction of the illumination process operation of an exemplary embodiment of the CAD.

FIG. 5 is a flow diagram illustrating exemplary steps in an exemplary embodiment of a CAD.

FIG. 6 is a functional block diagram of the components of an exemplary embodiment of a system or sub-system that could be used as a platform to implement various embodiments or aspects of the various embodiments.

### DETAILED DESCRIPTION

The various embodiments of the present invention, as well as features and aspects thereof, are directed towards the detection of system and network compromises, and more specifically, towards providing a system and method for detecting and assessing potential cyber-attacks in a computer system/network.

Embodiments of the present invention are directed towards software and/or hardware systems, components, programs, applications, computers, etc. that operate to monitor network activity within an entity's network and to identify abnormal, new, fringe, and/or suspicious activity that deviates from what would be considered as normal activity, hereinafter referred to as abnormal activity. Once abnormal activity is identified, the various embodiments may operate to flag such activity, especially if it appears to be part of an attack or could potentially be part of an attack. The various embodiments of the present invention will be referred to as the Cyber Attack Detector System or CADS.

Extensive observation of the way data breaches occur can provide a good indication of the steps involved in the compromise process. Table 1 presents an exemplary overview of this process.

TABLE 1
Cyber Attack Sequencing

| | |
|---|---|
| Step 1 | A cyber attacker tricks employees to download a |
| | disguised piece of malware. This process is done |
| | typically using email as a vector of attack. |
| Step 2 | If the attack is successful, the now compromised |
| | device will attempt to connect with a host |
| | belonging to the cyber attacker seeking |
| | instructions and/or to exfiltrate information. |
| Step 3 | In cases where the compromised device does not |
| | have the cyber attacker's data of interest, |
| | it will attempt to spread the compromises to |
| | other computers within the now compromised |
| | network. |
| Step 4 | Once the cyber attacker gets access to |
| | information of value, he or she will attempt to |
| | exfiltrate it by contacting a host belonging to |
| | the cyber attacker, as similarly described in step 2. |

Exemplary embodiments of the CADS operate to detect cyber-attack sequencing as presented in Table 1, and/or variants thereof. Such activity can be detected by monitoring various network elements and traffic that is being passed between the network elements to identify cyber-attack sequencing. Exemplary network elements where cyber-attack sequencing can be detected and/or identified are described in Table 2. The network data identified in Table 2 is referred to herein as network metadata.

TABLE 2
Network Metadata Detection

| Network Metadata | Relevance |
|---|---|
| DNS Queries | Collecting DNS Queries provides context |
| | with regards to attempted connections |
| | from devices within the organization |
| | network or system towards an external |
| | device/system such as a cyber |
| | attacker's infrastructure. |
| Network Flows | Among other malicious behavior, network |
| | flows provide insights into an organization's |
| | devices that are controlled by the cyber |
| | attacker and attempts to move laterally. |
| Access Logs of Perimeter | In cases where the attacks avoid domain |
| Proxies or Firewalls | resolution, the traces of adversarial |
| | contacts will lie in the access log of |
| | firewalls or proxies, depending on the |
| | organization's network configuration. |
| Spambox | Email is the preferred method by attackers |
| | to deliver attacks to the organization's |
| | end-users. Analyzing the organization's |
| | spambox provide insights into the type of |
| | attacks an organization is receiving, but |
| | more importantly if end-users are accessing |
| | such attacks and the organization is at a |
| | high risk of compromise. |

In an exemplary embodiment, a system configured to assess network compromises may incorporate the capabilities to capture the described network metadata in near real-time from the multiple environments that an organization uses in the day-to-day activities of its operation.

New attacks are created by adversarial entities on a daily basis. The various embodiments of the CADS implement mechanisms and procedures to identify, classify and categorize system and network activity as normal or abnormal activity and then to filter out or provide alerts for abnormal activity. In essence, this is accomplished by examining activity and first identifying activity that correlates with known threats and then classifying the activity as normal activity for the participating entities, systems, time of day and other logistics, or new or unknown activity (something different). One of the techniques to classify activity as normal activity is by maintaining a database of metadata for a prolonged period of time, such as 3 years or more as a non-limiting example, and then comparing identified activity with previously occurring activity to see if the activity is common. Further, when an attack is detected or identified, the historical activity as represented in the metadata storage can be examined to see if that particular attack or threat has previously occurred. As such, the various embodiments can be used to identify or illuminate problems, such as threats, breaches, attacks, attempted hacks, etc. and illuminate the problems by identifying the what, where and when. This information can then be used to trigger a shutdown of the system, limit system access, sounding of an alarm and/or simply to log the activity.

One aspect of the various embodiments of the CADS is to glean information from the meta data. The meta data provides information about what entities are contacting what other entities rather than actually identifying what was communicated between the entities. Thus, the metadata can be examined to identify if a component within the system is attempting to contact a suspected external system or an internal system in a manner that is suspicious.

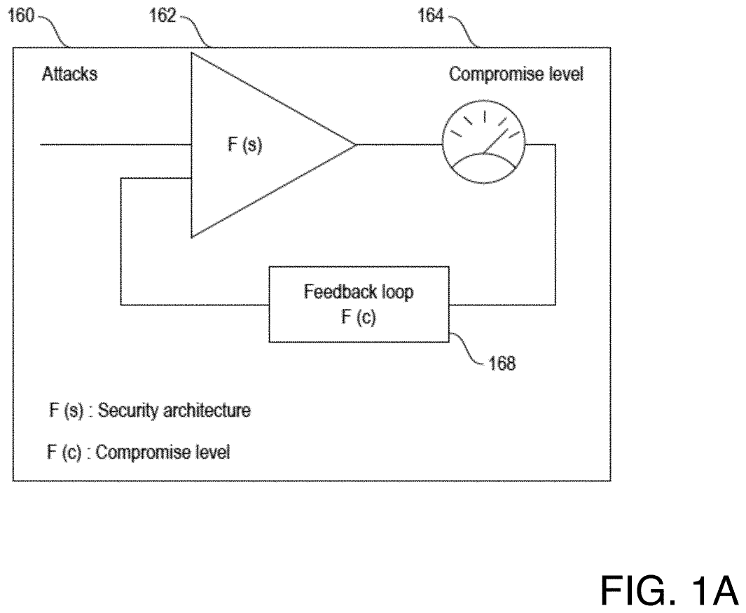

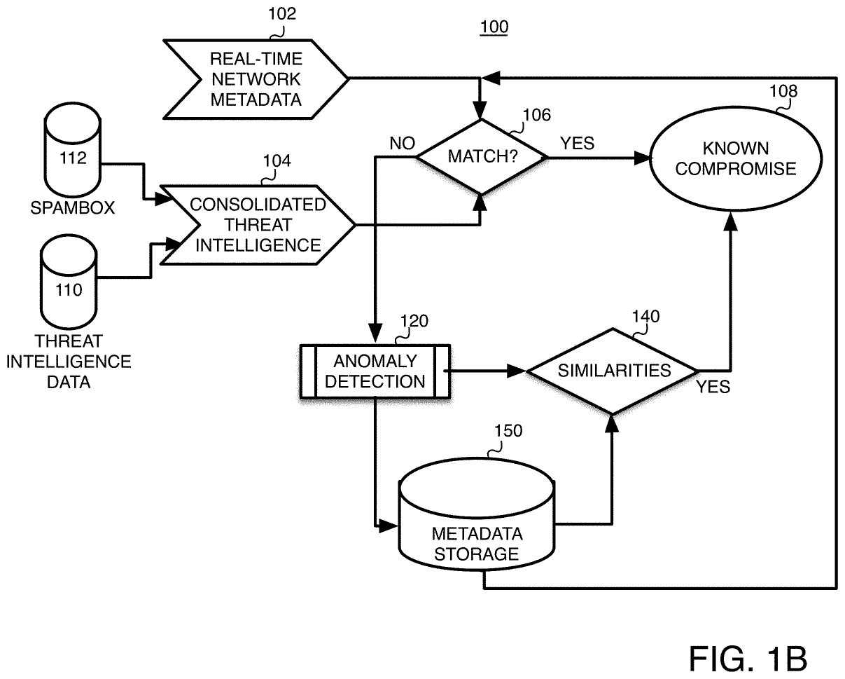

The operation of various embodiments of the CADS can be more appreciated by examining the figures. FIG. 1A is a simplified block diagram illustrating the functionality of various embodiments of the CADS. In general, any activity that occurs relative to a system, network or infrastructure, either generated internally or as from the result of external sources, are examined to determine if such activity may be a threat or attack 160. The activity is passed through the security architecture and is compared to known threats or attacks F(s) 162. Activity that is identified as an attack is then processed and activity that is determined to be allowed is passed through the system. However, activity that is in the gray zone (i.e., not identified as a known threat or attack but not determined to be clean or authorized or expected) is then rated as to its compromise level 164, and then the activity is processed F(c) 168 and used by adding it back into the security architecture to assist in analyzing future activity and/or passed back through the security architecture for further analysis F(s) 162. Thus, with the feedback structure 168, the various embodiments operate to augment and enhance security testing with continuous compromise protection. The feedback aspect operates to increase the cyber-resilience of the system and ultimately, the various embodiments operate to maximize the output of a security investment. Thus, it will be appreciated that the various embodiments operate to not only detect cyber-attacks or threats, but also to learn through monitoring activity with the system to continually enhance the efficacy of the security system to push towards minimal or zero success rates of attacks.

FIG. 1B is a block diagram illustrating further details of the operation of various system/network components and the information flow between such components in an exemplary methodology to access network metadata and to highlight compromises that could adversely impact the security of a system/network and thus compromise an organization.

One activity in the process of detecting network compromises 100 involves the capturing and the examination of real-time network metadata 102, which can include DNS inquiries, network flows, access logs and emails as non-limiting examples. The real-time network metadata 102 can be captured using a variety of techniques known to those skilled in the relevant art including network traffic monitors, sniffers, capture tools, etc. Non-limiting examples of such tools include NETFORT LANGUARDIAN, SOLARWINDS NTA, WIRESHARK, PAESSLER PACTEK CAPTURE, MICROSOFT MESSAGE ANALYZER as well as custom proprietary software/hardware solutions. These and other similar tools can be used to obtain application traffic, perform bandwidth monitoring, wire data analytics, perform network traffic analysis, perform network traffic forensics, etc.

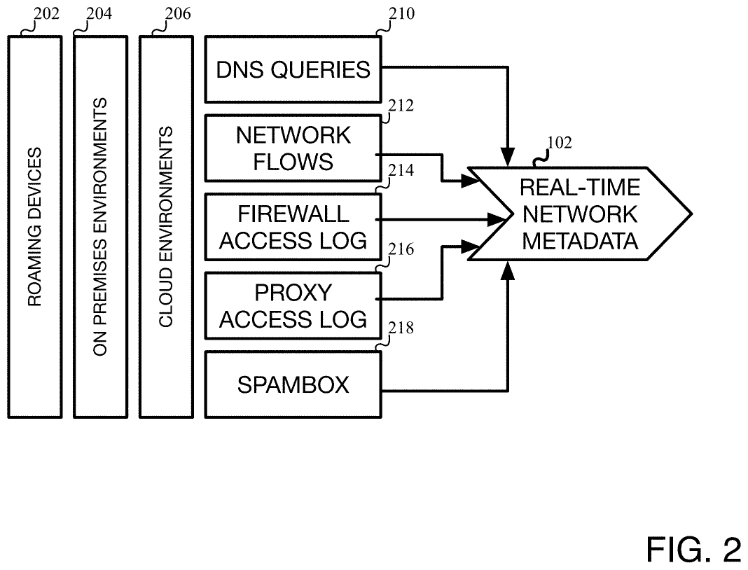

It should be clear from the forgoing that the old adage could not be more true here than anywhere “garbage in—garbage out”. As such, the strength of the detection and compromise prevention of the various embodiments of the CAD is greatly dependent upon the ability to collect and obtain an abundance of good data. FIG. 2 is a flow diagram illustrating an exemplary method to capture real-time network metadata for multiple environments. The real-time network metadata 102 can be derived from a wide variety of sources. The real-time metadata 102 presented in FIG. 2 may comprise data from a wide variety of sources. A list of these exemplary sources are provided and described in FIG. 2; however, it should be understood that these are non-limiting examples and as such, the various embodiments anticipate obtaining data from other sources as well.

The metadata can be received or obtained from roaming devices 202, on premises environments 204 and cloud environments 206. The types of data obtained from these devices or systems can be varied as well. The metadata can thus be obtained from DNS queries 210, network flows 212, firewall access logs 214, proxy access logs 216 and spambox 218 as a few non-limiting examples.

This captured real-time network metadata 102 can then be compared to threat intelligence data 104. Threat intelligence data 104 is information that is known to be used by cyber attackers. There are extensive data sources of threat intelligence data 110 that have been and that are being collected and curated by multiple public and private organizations in the industry. Threat intelligence can include a wide variety of detail about a threat, including where it originated, who coded it, who has modified it since its inception, how it's delivered, the kind of damage it does, and numerous other traits and signifiers. In addition to indicators of specific malware, threat intelligence also covers the tools and tactics cyber-attackers use, details on specific types of attacks, and dynamic information about potential risks and new risk sources. The benefit of accumulating threat intelligence data is that by compiling up-to-date information about known threats (i.e., IP addresses, domain names, file hashes, etc.), recipients of such information may be able to better defend their systems from future attacks. Thus, a wide array of public and commercial sources distribute threat intelligence data feeds to support this purpose.

The more volume and quality of threat intelligence data strengthens the capabilities of the process of detecting network compromises 100. Threat intelligence data helps to detect existing, evolving, and emerging threats, and it also helps predict future threat sources and future attack types, and it empowers businesses to implement strong risk management policies.

In addition to generic threat intelligence data, a specific feed of threat intelligence data can be compiled from the spambox 112 of the organization. An exemplary system captures the spambox 112 of the organization by simply forwarding of emails labeled as spam to a specific email address for the purpose of analysis or URLs, Domains and IP Addresses. However, any other method can be used for this purpose.

If the comparison of the captured metadata 102 and the threat intelligence data 104 results in a match 106, the matching metadata 102 may be indicative that a compromise has occurred or an attack is being attempted—this is referred to as a known compromise 108. Once detected, the appropriate action can be triggered such as shutting down the system, blocking external access, reporting or sounding an alarm, etc.

Another activity in the process of network compromise detection 100 involves the identification of anomalies 120 in network metadata that deviates from normal behavior that has been previously observed for devices within the network. This process involves the application of various techniques involving statistical analysis and machine learning. When detecting anomalies within a network based on network metadata, several techniques can be used. In one embodiment a simple ranking with some decay factor could be used to alert any new contact that is not listed in the ranking. Such a simple technique may be impractical in very heterogeneous networks but when used in stable and low traffic environments it may be good enough. In another embodiment, an adaptation of a generative statistical model such as LDA could be used to identify contacts that do not match the usual patterns of the observed network. In natural language processing, the latent Dirichlet allocation (LDA) is a generative statistical model that allows sets of observations to be explained by unobserved groups that explain why some parts of the data are similar. The use of LDA to detect network anomalies has been widely documented in academic research as well as introduced into tools such as Apache Spot. Another not-limiting example would be the usage of meta-models or deep learning techniques to learn and adjust over the time the normal contact patterns of any network or individual element of a network to identify when it suddenly starts to contact unusual infrastructure.

Thus, if a match 106 between the real-time network metadata 102 and the threat intelligence data 104 is not detected, the real-time network metadata 102 can be passed to the anomaly detection system 120. The anomaly detection system 120 can compare the real-time network metadata 102 with previously received metadata that is stored in the metadata storage 150 as well as historical operation of the system. If a metadata anomaly is identified 140, the process of network compromise detection 100 operates to measure the similarities between confirmed threat intelligence data 104 and metadata anomalies. This measurement can be accomplished by comparing various aspects of the real-time network metadata, such as ownership information, and the threat intelligence data, or by doing a deeper analysis using passive DNS data to identify if the real-time network metadata anomaly has resulted in an attack. It should be appreciated that in some embodiments, both a comparison of ownership information and a deeper analysis using passive DNS data can be combined in determining if a compromise has occurred or an attack is being levied.

It should be appreciated by those skilled in the relevant art that a typical problem of the industry is the inability to identify past network compromises from new threat intelligence data. Advantageously embodiments of the CADS operate to solve this problem by collecting the real-time network metadata that was not alerted in any of the previous actions and storing this metadata for a specific period of time in a metadata storage area 150.

Every time new threat intelligence data is loaded into the systems, the previously described actions of the network compromise detection 100 should not only be run against new real-time network metadata 102 but also against stored network metadata 150. Advantageously, this process can highlight new, occurring threats as well as attacks and/or compromises that have occurred in the past.

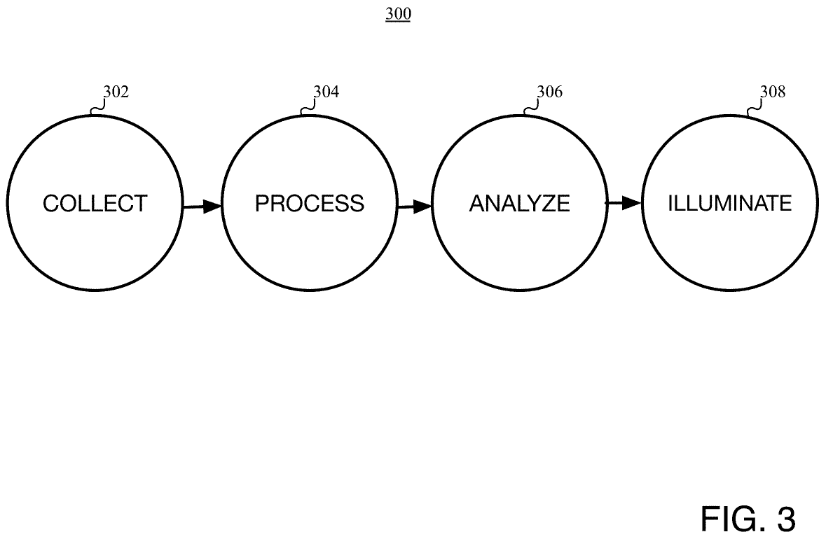

The various embodiments of the CADS operate to provide continuous compromise assessment. FIG. 3 is a general flow diagram of an exemplary process performed in exemplary embodiments of the CADS. The continuous process 300 first involves the collection of data 302, such as by gathering information from enterprise sources. Next, the flow involves processing of the data 304. In processing 304, the data is standardized and fed to a data ingest platform. The standardization process abstracts from the peculiarities of each data collection device and creates, for each feed type, a stream of uniformly formatted data. Peculiarities can include fields in excess to the ones we expect or missing information. The standardization process therefore—besides converting the format—removes unexpected data fields and adds default values for missing fields. Next the processed data is analyzed 306. During the analysis 306, the data is examined to find threats and anomalies within the infrastructure. Finally, the analyzed data is illuminated 308 to identify actions to be taken regarding the threats.

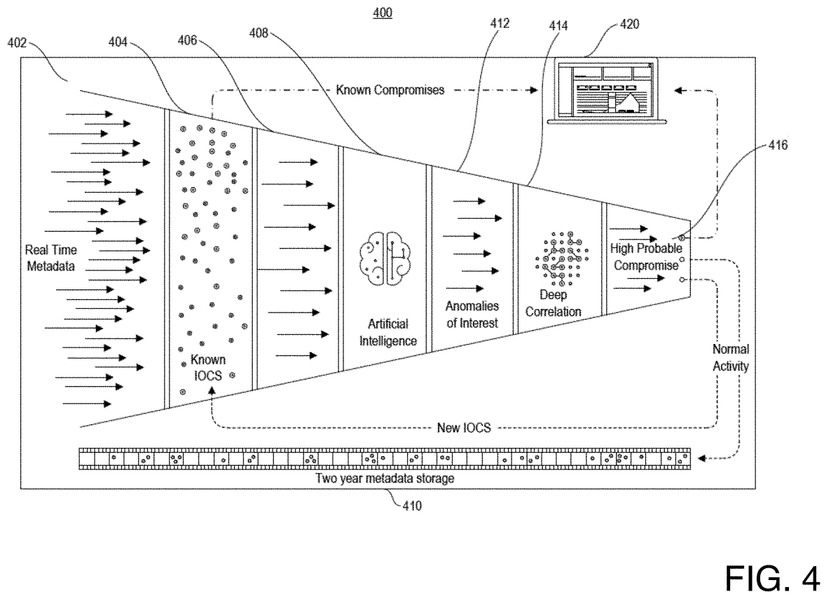

FIG. 4 presents a conceptual depiction of the illumination process operation of an exemplary embodiment of the CAD. The overall flow of the meta data analysis can be viewed as a funnel 400. It should be appreciated that the illumination process may typically be resident and run in the cloud but, in other implementations it could be within an enterprises system, distributed amongst enterprise components or otherwise configured. As illustrated at the large end of the funnel 400, real-time meta data 402 is received by the system. This real-time meta data 402 is examined and compared to known compromises 404. If this comparison results in the detection of an attempted attack or potential compromise, the known compromise is then reported to a customer portal 420. The real-time meta data that does not correspond to a known compromise is then passed further into the funnel 400 as remaining activities 406. The remaining activities 406 are then passed to and processed through an artificial intelligence processing system 408. One operation of the artificial intelligence processing system 408 is to compare the remaining activities 406 to the historical activity of meta data 410. In an exemplary embodiment, the system may maintain the last two-years of metadata. In other embodiments, the meta data storage may include more or less historical meta data storage. The artificial intelligence processing system 408 operates to classify the remaining activities 406 as either normal activity (i.e., activity that has occurred and is present in the historical activity of meta data 410) and unknown activity. The remaining activities 406 can be classified as unknown activity under a variety of circumstances. As non-limiting examples, the artificial intelligence processing system 408 may classify remaining activities meta data as unknown or abnormal under the following situations:

(1) activity that has not previously occurred before or that is not within the stored historical activity of meta data 410;

(2) activity that has not occurred for a threshold period of time, such as 1 year, 6 months, 2 years, etc.;

(3) activity that has occurred only seldomly, such as only appearing once or twice in the historical activity of meta data 410; and

(4) activity that has previously only occurred under certain circumstances which are not currently present,

This last situation may take on many forms. A few non-limiting examples of these forms may include:

(a) the activity has only previously occurred during working hours but is presently occurring outside of working hours;

(b) the activity has previously been associated with a specific set of devices but is presently invoking or accessing different devices;

(c) the activity has previously occurred according to a periodic pattern, such as once a day, once a week, every 6 hours, etc., but is presently breaking this periodic pattern;

(d) the activity has previously only been initiated by a specific system or a known system but is presently being initiated by a different system or an unknown system; and/or

(e) the activity has previously included a known set of parameters but is presently utilizing a different set of parameters.

The unknown activity, as well as the known activity can be passed through the artificial intelligence processing system 408, or a web of artificial intelligence to identify issues and trends related to the activity. Of the activities, some may be earmarked as anomalies of interest 412. The anomalies of interest 412 can then be subjected to a deep correlation analysis 414 to identify if the activities represent a high probability of compromise 416. In order to identify high probable compromise, the system calculates what may be called the technical distance between previously known-to-be-attacks or known-attack-patterns and the anomaly in question. The closer the anomaly to previously known attacks/patterns the higher its probability of being a compromise. Such a technical distance may be calculated using several techniques, from simple rule-sets to complex arrays of statistical models or machine learning techniques. Input for those techniques may be based on all the intelligence that can be obtain about the domain or ip address related to the potential attack; including but not limited to: geolocation data, ASN information (IP address's Autonomous System Number (ASN) may include information such as the IP owner, registration date, issuing registrar and the max range of the AS with total IPs), domain age, domain resolution information, previous relations to malicious campaigns or to reputable actors, information about Transport Layer Security (TLS) encryption certificates, type of content hosted if any, hosting provider information, entropy level of the used domain, related ISP, details about the most recent contact attempt, such us protocol, port, etc. Such input may be feed directly or preprocessed in order to obtain a feature-set that fits any used model or technique used. This real-time meta data that represent high probability of compromise 416 may then be reported to the customer portal 420. For anomalies of interest that are not classified as a high probability of compromise 416 but that do not correlate with known normal activity can be identified as new Indicators of Compromise (“IOCs”) and run back through the analysis funnel.

IOCs serve as forensic evidence of potential intrusions on a host system or network. These artifacts enable information security (InfoSec) professionals and system administrators to detect intrusion attempts or other malicious activities. IOCs can be viewed as the proverbial “breadcrumbs” that can be followed to assist in identifying threatening activity on a system or network. This forensic data assists information technologist and security professionals to identify data breaches, malware infections, and other security threats. Monitoring all activity on a network to understand potential indicators of compromise allows for early detection of malicious activity and breaches.

When unknown or abnormal activity is identified as an IOC, that particular activity may be an indicator of a potential or an in-progress threat. Unfortunately, it can be exceedingly difficult to detect IOCs. For instance, an IOC can be as de minimis as a simple metadata element or incredibly complex malicious code and content stamps that slip through the cracks. To detect some of these IOCs, the system or personal need to have a good understanding of what activity is normal for a given network—then, they have to identify various IOCs to look for correlations that piece together to signify a potential threat.

In addition to Indicators of Compromise, there are also Indicators of Attack (“IOA”). IOAs can be very similar to IOCs, but rather than identifying a potential compromise or an in progress compromise, the IOAs point to the activity of an attacker while an attack is in taking place.

Thus, it is essential that a system is actively proactive in searching for and identifying IOCs and IOAs. Early warning signs can be hard to decipher but analyzing and understanding them, through IOC security, gives the best chance at protecting a system and network.

As non-limiting examples, some typical IOCs that may occur and that need to be watched for may include the following:
(1) Unusual Outbound Network Traffic. Traffic within the network can be an indicator of a potential compromise. If the outbound traffic increases heavily or is not following normal patterns, this may indicate a potential compromise. Fortunately, the traffic within a network can easily be monitored and analyzed. Because of this, the internetwork traffic may give an indicator of a potential compromise before any significant damage occurs to the network.
(2) Anomalies in Privileged User Account Activity. Monitoring privileged accounts in a system may result in identifying account takeovers and insider attacks. If abnormal account activity is detected, it can be marked as an IOC. For instance, an escalation in the privileges of an account or an account being used to access other accounts with higher privileges can be flagged as IOCs.
(3) Geographic Irregularities. Activities that occur from an unusual or unknown geographic location, such as log-ins and data access, regardless of the account being used, may be an indicator that a hostile entity is accessing the system or network. For instance, if traffic is detected from countries, states, cities or localities in which the company does not typically do business, this should be classified as an IOC and examined closely. This is especially true if a large number of log-ins from a particular unusual geographic location are detected.
(4) Anomalies in Log-Ins. Any irregularities in logging into the system can be classified as an IOC. This may include a large number of failed login for an existing account or login attempts to accounts that do not exist. This activity can be spread out across a significant period of time in an attempt to camouflage the activity and so, it is beneficial for the system to mark login in failures and save them for historical evaluation.
(5) Increased Volume in Database Reads. Monitoring and keeping track of typical database read activity in a system can be imperative in identifying threats or attacks. Large volume reads of a database, especially one that contains sensitive information, can be examined based on known and expected activity to ascertain if a breach has occurred and data is being exfiltrated.
(6) Large HTML Response. An HTML response that includes a large amount of data, especially if it is unexpected or abnormal under the particular conditions, may be an indicator that data is being exfiltrated. Typical HTML response are on the order of 100's of KB. If a response pulls data in the range of MBs, it may indicated that a compromise in is process.
(7) Large Number and Repeated Requests for the Same File. For files that are encrypted and re-encrypted, a large number of requests for those files can be used to help reverse engineer the encryption technology. In addition, hostile entities may need to request files several times in an effort to determine what technique is going to work. As such, a large number of requests should be identified as an IOC.
(8) Mismatched Port-Application Traffic. If a system as a port that is not often used, hostile entities may attempt to exploit this port. As such, any attempts to access data or the system through such a port should be identified as an IOC.
(9) Suspicious Registry. One technique that malware utilizes is an infected host is registry changes. This activity may include packet-sniffing software that deploys harvesting tools. Maintaining a baseline normal status for registries can be utilized to detect abnormal activity.
(10) DNS Request Anomalies. Command-and-control traffic patterns are oftentimes left by malware and cyber attackers. The command-and-control traffic allows for ongoing management of the attack. An increased spike in DNS requests from a specific host is indicative of an IOC. External hosts.

One potential operation in embodiments of the CADS is to perform an analysis by examining netflows. Netflows identify what devices in the enterprise perimeter talk to each other. Thus, if a device within the enterprise perimeter is attempting to contact the main server, this can be examined to determine if it is a normal activity based on time, space, quantity, mannerisms, etc. As such, if a device within the enterprise perimeter has been compromised, embodiments of the CAD can detect this if the device attempts to do something different from its normal activities. Again, in this case normal can be defined by examining the meta data history for that device.

Another operation in the analysis is examining DNS information for activities. For example, if a virus infiltrates a component or device within the enterprise perimeter, it may attempt to give access to that component or device to some outside entity. DNS request used in typical malware will resolve a URL. The DNS can thus be used to extradite data. Because the use of DNS activity is common within a network, it is a common target for attacks. Thus, examining where the DNS's ultimately resolve to helps to identify anomalies of interest.

The various embodiments of the CAD can create a feedback flow of risks and questionable activity that can be used to help adjust the compromise level of the system and aim towards a security architecture that has zero compromises. Thus, as illustrated in FIG. 4, three classifications of outputs of the funnel 400 are illustrated. If the real-time meta data is determined by deep correlation examination 414 to be a high risk of compromise 416, a notification pertaining to this particular meta data is passed to the customer portal 420. This enables an operator or system administrator to be notified of a potential risk and provide instructions on how to proceed. If it is determined that a particular element of real-time meta data is normal activity, this can simply be logged into the activity history storage 410. If a particular element of real-time meta data is determined to be a new IOC, this information can be passed to the customer portion 420 to invoke counter measures but, is also fed back to the known compromises data store 404 to be used for detecting similar IOCs and to be reexamined against the previously known again.

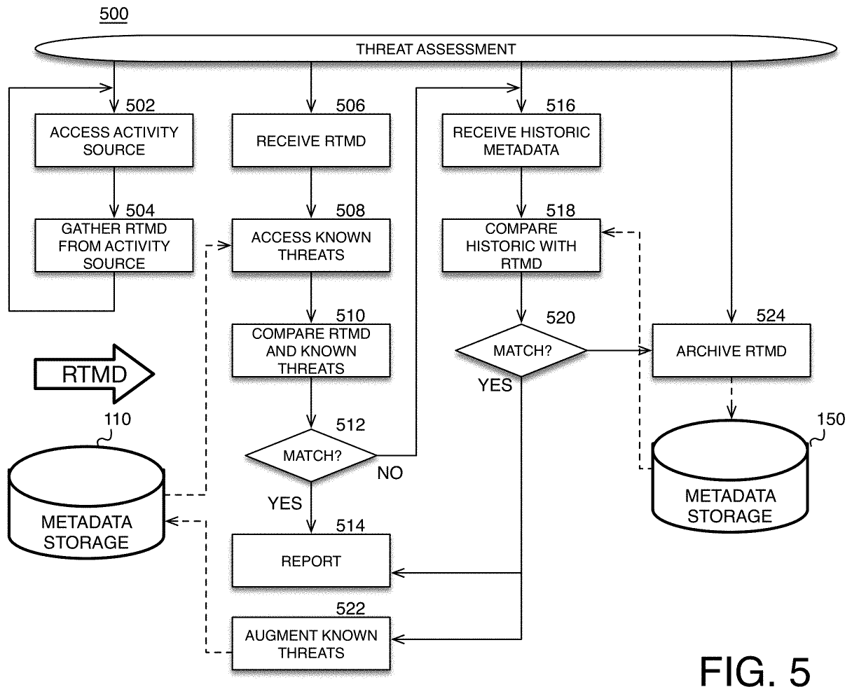

FIG. 5 is a flow diagram illustrating exemplary steps in an exemplary embodiment of a CAD. The illustrated flow operates to decrease vulnerability of a system to attacks. The threat assessment method 500 continuously interfaces with activity sources 502 to gather a plurality of instances of real-time metadata 504. For each instance of real-time metadata (RTMD), the embodiment conducts a threat assessment. The threat assessment 500 includes first comparing each instance of the gathered real-time metadata to one or more of a plurality of known threat intelligence signatures. Thus, the threat assessment 500 obtains each instance of real-time metadata 506 and accesses a source of known threat intelligence signatures 508. As previously described, a wide variety of sources can be pooled for obtaining this information. But in essence, each known threat intelligence signature includes one or more parameters to define the known threat. The threat assessment 500 then compares each instance of real-time metadata to the known threat intelligence signatures 510 (i.e., obtained from a source of known threats such as element 110 in FIG. 1B) to identify a match. If a match is found 512, this discover is reported or flagged 514 to indicate that a particular instance of real-time metadata is a threat.

If the comparison of an instance of real-time metadata does not correspond or match with any of the one or more of the plurality of known threat intelligence signatures 512, the embodiment then examines the instance of real-time metadata to determine if it is a suspected threat. To examine the real-time metadata to determine if it is a threat, the threat assessment 500 retrieves historic metadata from a metadata store 516. The instance of real-time metadata is then compared to the historic metadata 518. As previously described, this comparison can be quite involved and is typically more than just comparing real-time metadata to historic metadata. The matching criteria may look to see if the real-time metadata matches previously received metadata in content and in practice (i.e., it is historically received in the same fashion, manner, timing, and other parameters as previously described). For each instance of real-time metadata that matches the criteria 520, and thus is determined to be a suspected threat, the threat assessment, reports the instance of real-time metadata as a threat 514. Further, the threat assessment 500 also augments 522 the plurality of known threat intelligence signatures 110 to include the suspected threat.

Finally, if the instance of real-time metadata does not match the criteria with the historic metadata 520, the instance of real-time metadata is archived 524 into the metadata historic storage 150 (such as in FIG. 1B). Further, the threat assessment 500 also operates to archive all of the instance of real-time metadata 524 into the historic metadata storage along with parameters regarding the real-time metadata, such as the source, the time of receipt, the destination, etc. This information is then made available for further threat assessments.

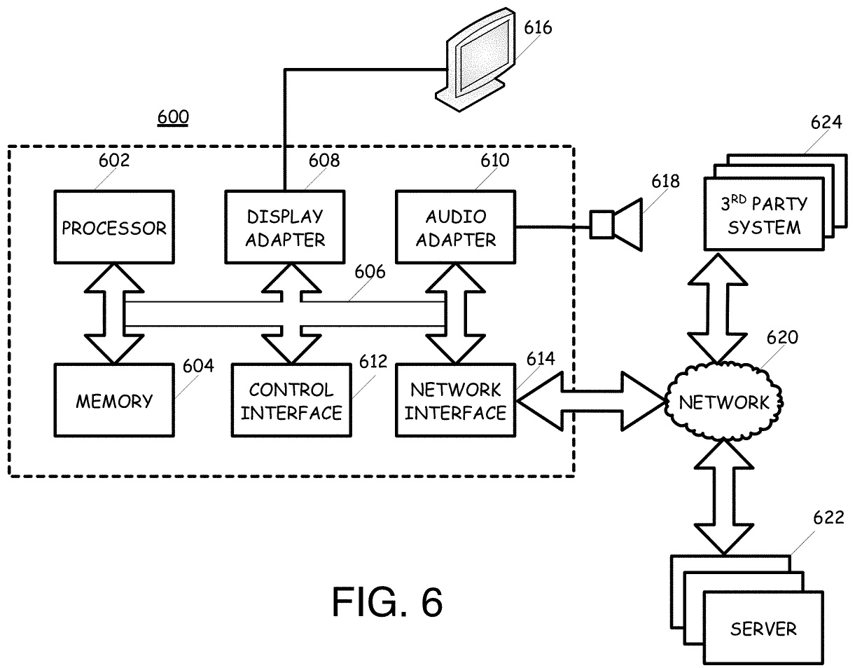

FIG. 6 is a functional block diagram of the components of an exemplary embodiment of a system or sub-system that could be used as a platform to implement various embodiments or aspects of the various embodiments. It will be appreciated that not all of the components illustrated in FIG. 6 are required in all embodiments of the activity monitor but, each of the components are presented and described in conjunction with FIG. 6 to provide a complete and overall understanding of the components. The controller can include a general computing platform 500 illustrated as including a processor/memory device 502/604 that may be integrated with each other or, communicatively connected over a bus or similar interface 606. The processor 502 can be a variety of processor types including microprocessors, micro-controllers, programmable arrays, custom IC's etc. and may also include single or multiple processors with or without accelerators or the like. The memory element of 604 may include a variety of structures, including but not limited to RAM, ROM, magnetic media, optical media, bubble memory, FLASH memory, EPROM, EEPROM, etc. The processor 602, or other components in the controller may also provide components such as a real-time clock, analog to digital convertors, digital to analog convertors, etc. The processor 602 also interfaces to a variety of elements including a control interface 612, a display adapter 608, an audio adapter 610, and network/device interface 6514. The control interface 612 provides an interface to external controls, such as sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 608 can be used to drive a variety of alert elements 616, such as display devices including an LED display, LCD display, one or more LEDs or other display devices. The audio adapter 610 interfaces to and drives another alert element 618, such as a speaker or speaker system, buzzer, bell, etc. The network/interface 614 may interface to a network 620 which may be any type of network including, but not limited to the Internet, a global network, a wide area network, a local area network, a wired network, a wireless network or any other network type including hybrids. Through the network 620, or even directly, the controller 600 can interface to other devices or computing platforms such as one or more servers 622 and/or third party systems 624. A battery or power source provides power for the controller 500. It should be appreciated that each of the functional components of various embodiments of the CADS may be constructed from hardware, software, firmware, or a combination thereof. Thus, aspects of the system may include software components being read from a tangible media and executed by a processor, while other aspects may be fully based on hardware including servers, custom ICs, or circuit components as non-limiting examples.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method to decrease vulnerability of a system to attacks, the method comprising the actions of:
continuously interfacing to activity sources to gather a plurality of instances of real-time metadata;
for each instance of real-time metadata, conducting a threat assessment by:
comparing each instance of the gathered real-time metadata to one or more of a plurality of known threat intelligence signatures;
for each instance of real-time metadata that corresponds with one or more of the plurality of known threat intelligence signatures, reporting the instance of real-time metadata as a threat;
for each instance of real-time metadata that does not correspond with one or more of the plurality of known threat intelligence signatures, examining the instance of real-time metadata to determine if it is a suspected threat; and
for each instance of real-time metadata that is determined to be a suspected threat:
reporting the instance of real-time metadata as a threat; and
augmenting the plurality of known threat intelligence signatures to include the suspected threat; and
archiving each of the plurality of instances of real-time data into a metadata storage container to be utilized for further threat assessment.

2. The method of claim 1, wherein the action of interfacing to activity sources to gather a plurality of instances of real-time metadata further comprises:
interfacing to each of a plurality of access points that are accessed by roaming devices.

3. The method of claim 1, wherein the action of interfacing to activity sources to gather a plurality of instances of real-time metadata further comprises:
interfacing to each of a plurality of components within the system.

4. The method of claim 1, wherein the action of interfacing to activity sources to gather a plurality of instances of real-time metadata further comprises:
interfacing to each of a plurality of cloud environments that interact with the system.

5. The method of claim 1, wherein the action of interfacing to activity sources to gather a plurality of instances of real-time metadata further comprises:
gathering network flows.

6. The method of claim 1, wherein the action of interfacing to activity sources to gather a plurality of instances of real-time metadata further comprises:
gathering entries in a firewall access log.

7. The method of claim 1, wherein the action of interfacing to activity sources to gather a plurality of instances of real-time metadata further comprises:
gathering entries in a proxy access log.

8. The method of claim 1, wherein the action of interfacing to activity sources to gather a plurality of instances of real-time metadata further comprises:
gathering items routed to one or more of a plurality of spamboxes in the system.

9. The method of claim 1, wherein the action of examining the instance of real-time metadata to determine if it is a suspected threat comprises:
comparing the instance of real-time metadata to previously processed metadata.

10. The method of claim 1, wherein the action of examining the instance of real-time metadata to determine if it is a suspected threat comprises:
determining if the instance of real-time metadata matches previously processed metadata; and
analyzing the occurrence of the instance of real-time data with occurrence of matching previously processed metadata to identify if the instance of real-time data is similar to the matching previously processed metadata.

11. A system to decrease vulnerability of a system to attacks, the system comprising:
a metadata collector that is configured to continuously interfacing to activity sources to gather a plurality of instances of real-time metadata;
a known threat source containing one or more known threat signatures;
a metadata store configured to contain metadata previously gather within the system;
a threat assessment system comprising a processor and a memory element containing instructions that when executed by the processor enable the threat assessment system to:
access the one or more known threat signatures in the known threat source and to access the metadata collector to receive each of the instances of real-time metadata and then to compare each instance of the gathered real-time metadata to one or more of the plurality of known threat intelligence signatures;
report each of the instances of real-time metadata as a threat when the instance of real-time metadata corresponds with one or more of the plurality of known threat intelligence signatures;
interface to the metadata store to access the previously gathered metadata, and for each instance of the real-time metadata that does not correspond with one or more of the plurality of known threat intelligence signatures, compare the instance of the real-time metadata to the previously gathered metadata;
report the instance of real-time metadata as a threat based on the comparison;
augment the plurality of known threat intelligence signatures to include the suspected threat; and
archiving each of the plurality of instances of real-time data into a metadata storage container to be utilized for further threat assessment.

12. The system of claim 11, wherein the metadata collector that is configured to continuously interfacing to activity sources to gather a plurality of instances of real-time metadata by interfacing to each of a plurality of access points that are accessed by roaming devices.

13. The system of claim 11, wherein the metadata collector that is configured to continuously interfacing to activity sources to gather a plurality of instances of real-time metadata by interfacing to each of a plurality of components within the system.

14. The system of claim 11, wherein the metadata collector that is configured to continuously interfacing to activity sources to gather a plurality of instances of real-time metadata by interfacing to each of a plurality of cloud environments that interact with the system.

15. The system of claim 11, wherein the metadata collector that is configured to continuously interfacing to activity sources to gather a plurality of instances of real-time metadata by gathering network flows.

16. The system of claim 11, wherein the metadata collector that is configured to continuously interfacing to activity sources to gather a plurality of instances of real-time metadata by gathering entries in a firewall access log.

17. The system of claim 11, wherein the metadata collector that is configured to continuously interfacing to activity sources to gather a plurality of instances of real-time metadata by gathering entries in a proxy access log.

18. The system of claim 11, wherein the metadata collector that is configured to continuously interfacing to activity sources to gather a plurality of instances of real-time metadata by gathering items routed to one or more of a plurality of spamboxes in the system.

19. The system of claim 11, wherein the threat assessment system is configured to interface to the metadata store to access the previously gathered metadata, and for each instance of the real-time metadata that does not correspond with one or more of the plurality of known threat intelligence signatures, compare the instance of the real-time metadata to the previously gathered metadata by comparing the instance of real-time metadata to previously processed metadata.

20. The system of claim 11, wherein the threat assessment system is configured to interface to the metadata store to access the previously gathered metadata, and for each instance of the real-time metadata that does not correspond with one or more of the plurality of known threat intelligence signatures, compare the instance of the real-time metadata to the previously gathered metadata by:
determining if the instance of real-time metadata matches previously processed metadata; and
analyzing the occurrence of the instance of real-time data with occurrence of matching previously processed metadata to identify if the instance of real-time data is similar to the matching previously processed metadata.
